(19) United States
(12) Patent Application Publication
(10) Pub. No.: US 2025/0344697 A1
(43) Pub. Date: Nov. 13, 2025

(54) ENANTIOMERICALLY ENRICHED FUNGICIDES FOR THE CONTROL OF RESISTANT PHYTOPATHOGENIC FUNGI

(71) Applicant: SYNGENTA CROP PROTECTION AG, Basel (CH)

(72) Inventors: Ulrich Johannes HAAS, Stein (CH); Stefano TORRIANI, Stein (CH); Dirk BALMER, Stein (CH)

(73) Assignee: SYNGENTA CROP PROTECTION AG, Basel (CH)

(21) Appl. No.: 18/860,425

(22) PCT Filed: Apr. 26, 2023
(86) PCT No.: PCT/EP2023/061028

§ 371 Date: Oct. 25, 2024

(30) Foreign Application Priority Data
Apr. 26, 2022 (EP) 22170141.0

(51) Int. Cl. A01N 43/653; A01P 3/00

(52) U.S. Cl. CPC A01N 43/653; A01P 3/00

(57) ABSTRACT

The present invention relates to a composition suitable for the control of 14α-demethylase inhibitor-resistant pathogenic fungi phenotypes, comprising: (A) an enantiomerically enriched or enantiomerically pure, levorotatory compound of formula (I), wherein R¹ and R² independently from each other are halogen, cyano, or C₁-C₃ haloalkyl, R³ is hydrogen, C₁-C₃alkyl, C₁-C₃alkenyl or C₁-C₃alkynyl, A is CH or N and X is CH₂, C(═O), O or S, and at least one additional agrochemically active component (B).

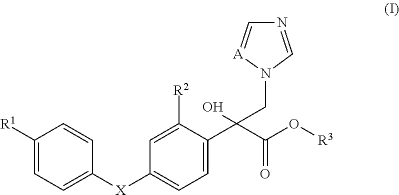

The present invention relates to novel fungicidal compositions suitable for control of diseases caused by phytopathogens, especially phytopathogenic fungi resistant to sterol biosynthesis C14α-demethylase inhibitor fungicides (DMI fungicides), and to a method of controlling these diseases on useful plants, especially cereals, fruits and vegetables, comprising treating the plants, their seed or the soil with a fungicidally effective amount of a compound of enantiomerically enriched compounds of formula (I), or the enantiomerically pure or enantiomerically enriched compound of the formula (I).

It is known from WO 2019/093522 that certain 2-hydroxypropanoate derivatives and mixtures comprising the 2-hydroxypropanoate derivatives have biological activity against phytopathogenic fungi, in particular versus septoria tritici blotch (STB). WO 2021/230382 discloses a process to prepare certain 2-hydroxypropanoate derivatives, among them levorotatory (−)-Methyl 2-[2-chloro-4-(4-chlorophenoxy)phenyl]-2-hydroxy-3-(1, 2,4-triazol-1-yl)propanoate in an enantiomeric excess of 90% ee, and its use for the treatment of a number of a number of Phytopathogenic Fungi. Racemic mixtures of such compounds have also been disclosed in US2022/217978 and WO2021/20936. While the latter document claims various benefits for any enantiomerically enriched formulations, these are effectively not disclosed herein.

Wheat, Triticum aestivum L., is a crop of global importance, with the European Union representing the world's highest producer. It is a major food and feed crop, a global commodity, and plays a critical role in supporting worldwide food security.

STB is the most devastating leaf disease on wheat and caused by the ascomycete Zymoseptoria tritici. This fungal pathogen thrives best under humid and temperate conditions, with several disease cycles per season possible. STB has been reported throughout Europe but is prevalent in regions that offer conducive climatic conditions such as the British Isles or Northern Germany. Infection with Zymoseptoria tritici usually results in necrotic areas on leaves, and often may also cause mixed infections with other co-pathogens.

To date, STB control remains highly reliant on frequent and timely applications of fungicides, as yield losses can amount to up to 50% if the disease is not efficiently controlled. One of the main fungicide groups employed are sterol biosynthesis C14α-demethylase inhibitors (DMI).

In particular, azole (triazole) fungicides acting as 14-alpha demethylase inhibitors have become essential components of plant disease control in the fields because of their wide-ranging efficacy against not only STB, but many agriculturally important diseases. However, field efficacies of many azole fungicides in crop protection have strongly reduced due to the emergence of resistance in their prolonged and intensive agricultural usage, and now most Z. tritici populations show mutations in the fungicide target genes.

Without wishing to be bound by any particular theory, it is believed that several molecular mechanisms play a role in reduced azole sensitivity. The most common mechanism is an alteration in the CYP51 gene, leading to amino acid changes of the CYP51 enzyme. To date, over 30 different amino acid alterations have been identified in the CYP51 protein of modern Z. tritici populations, and over 30 different genotypes have been registered so far.

WO 2020/078942 discloses that DMI resistant Septoria tritici comprising at least one mutation in the CYP51 gene could be addressed by racemic mixtures of compounds according to formula (X):

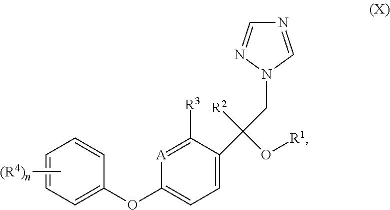

wherein A is CH or N; R¹ is selected from hydrogen, (C₁-C₆)-alkyl, C(O)CH₃; R² is selected from hydrogen, (C₁-C₆)-alkyl or (C₃-C₆)-cycloalkyl; R³ is selected from hydrogen, halogen, (C₁-C₆)-alkyl or (C₁-C₆)-haloalkyl; R⁴ is selected from halogen, (C₁-C₆)-alkyl, (C₁-C₆)-haloalkyl, (C₁-C₆)-alkoxy or (C₁-C₆)-haloalkoxy; and n=0, 1, 2, 3.

However, it was found that the efficacy of these compounds was insufficient to retain efficacy vis-à-vis certain strains of that have developed a higher resistance against this family of compounds. In particular mutations leading to exchanges L50S and 1381V, and deletions or mutations at nucleotides coding for amino acids 459-461 are also currently claimed to have the highest effect on the sensitivity to azoles, while the emergence of S524T in field populations of Z. tritici has caused particular concern as this has limited the remaining azole fungicides in their effective use against STB. Hence, several point mutations in Z. tritici populations have been associated with high EC₅₀ values.

Accordingly, it is therefore proposed in accordance with the present invention a novel composition suitable for the control of for the control of 14α-demethylase inhibitor-resistant pathogenic fungi phenotypes, in particular a 14α-demethylase inhibitor-resistant Z. tritici phenotype comprising at least one mutation in the CYP51 gene, L50S gene and/or 1381V gene, comprising:

(A) an enantiomerically enriched or enantiomerically pure, levorotatory compound of formula (I):

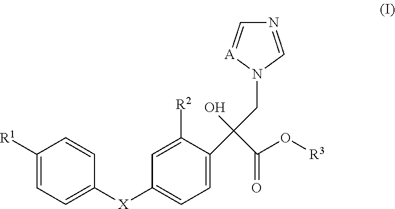

wherein R¹ and R² independently from each other are halogen, cyano, or C₁-C₃ haloalkyl, R³ is hydrogen, C₁-C₃alkyl, C₁-C₃alkenyl or C₁-C₃alkynyl, A is CH or N and X is CH₂, C(═O), O or S.

Advantageously, the enantiomerically enriched or enantiomerically pure, levorotatory compound (A) is not (−)-Methyl 2-[2-chloro-4-(4-chlorophenoxy)phenyl]-2-hydroxy-3-(1,2,4-triazol-1-yl) propanoate if present as the sole compound (A), in an enantiomeric excess of 90% over the dextrorotatory (+)Methyl 2-[2-chloro-4-(4-chlorophenoxy)phenyl]-2-hydroxy-3-(1, 2,4-triazol-1-yl)propanoate enantiomer of formula (I).

Preferably, the composition according to the present disclosure comprises at least one additional component (B), advantageously an agrochemically effective component or compound.

The presence of the asymmetric carbon atom in a compound of formula I means that the compounds occurs in optically isomeric forms, i.e. enantiomeric forms. Thus far, the compounds have only been disclosed as racemic mixtures.

The compounds of the invention containat least one key chiral center and, therefore, exist as enantiomers. According to this invention, the chemical structures depicted herein, including the compounds of this invention, encompass all of the corresponding compounds' enantiomers, that is, both the stereomerically pure form, i.e. enantiomerically pure, and enantiomerically enriched mixtures of the two enantiomers, whereby the weight ratio of the enantiomers is not 50:50.

While it is known that enantiomers can have profoundly different effects in biological systems, where ususally one enantiomer is biologically active while the other has little or no biological activity at all, applicants found that surprisingly, the use of each enantiomer was was more effective than the use of a racemate, for the control of 14α-demethylase inhibitor-resistant Z. tritici phenotype comprising at least one mutation in each of the CYP51 gene, L50S gene and 1381V genes, in particular also for those pheontypes that comprised mutations in genes V136A, YG591, Y461S and S524T. Preferably the composition may be used also against Z. tritici phenotypes comprising a mutation in genes S188N, A379G and N513K. Without wishing to be bound by any particular theory, it is believed that the presence ofboth enatniomers in the racemate results in an antagonistic effect, thereby reducing the efficiacy of the single enantiomers, as shown by the experimental results.

It was found that surprisingly, that the levorotary enantiomers possess superior activity as compared to the racemic mixture when applied to phytopathogenic fungi with increased resistance to C14α-demethylase inhibitor fungicides, also called DMI fungicides, as compared to the racemic mixture. However also surprisingly, the dextrorotary enantiomers also showed some efficacy when compared to the racemate, albeit much lower than their levorotary enantiomer counterpart, but often appear to render the racemates lower in activity than expected, resulting in an antagonistic effect.

The efficacy of the enantiomers vis-à-vis the racemate was calculated by comparing the EC50 values of the racemate versus the EC50 values of the pure enantiomers, showing that the L-enantiomer were surprisingly much more effective than expected versus a particular group of DMI resistant Z. tritici genotypes. The results also clearly showed that there is no simple or linear relationship between enantiomers and their efficacy.

Accordingly, the present invention encompasses mixtures comprising the enantiomerically enriched levorotary compounds of formula (I), or the enantiomerically pure levorotary compounds of the formula (I), and at least one additive, for the treatment or control of 14α-demethylase inhibitor-resistant Z. tritici phenotype comprising at least one mutation in each of the CYP51 gene, L50S gene and 1381V genes, in particular also for those pheontypes that comprised mutations in genes V136A, YG591, Y461S and S524T. PReferably the composition may be used also against Z. tritici phenotypes comprising a mutation in genes S188N, A379G and N513K.

It was also observed that the compounds according to formula (I) could not yet be crystallized, and hence they have been described by their ability to rotate plane-polarized light. An enantiomer that rotates plane-polarized light in the positive direction, or clockwise, is called dextrorotary [(+)], while the enantiomer that rotates the light in the negative direction, or counterclockwise, is called levorotary [(−)].

Preferred compositions are those comprising a levorotary enantiomer of formula (I)

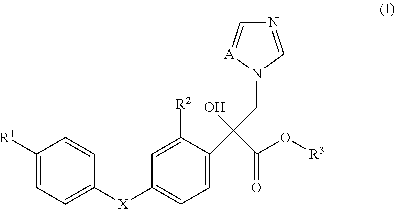

wherein R¹ represents halogen; more preferably chloro; R² represents halogen or trifluoromethyl, R³ represents methyl or ethyl, A represents N, and X represents C(═O) or O, more preferably O, in an enantiomerically enriched or enantiomerically pure form.

Preferred compositions are those comprising a compound of formula I

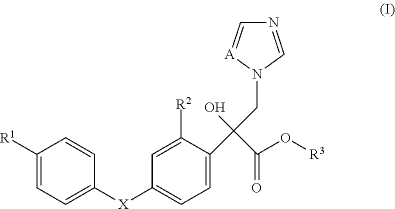

wherein R¹ represents halogen; R² represents halogen, R³ represents methyl or ethyl, A represents N, and X represents C(═O) or O, more preferably O, in an enantiomerically enriched or enantiomerically pure, levorotatory form.

Particularly preferred is the levorotatory enantiomerically pure compound of formula I, wherein R¹ represents chloro; R² represents chloro, R³ represents methyl, A represents N, and X represents O, preferably wherein the [α]_{D}²⁰ value in CHCl₃ has been determined as −97.26 [(−) enantiomer of Compound I-1].

Also particularly preferred is the levorotatory enantiomerically pure compound of formula I, wherein R¹ represents chloro; R² represents trifluoromethyl, R³ represents methyl, A represents N, and X represents O, preferably wherein the [α]_{D}²⁰ value in CHCl₃ of the compound has been determined as −20.54 [(−) enantiomer of Compound I-2].

It has been observed by the applicants that in particular the levorotatory enantiomers surprisingly and substantially enhances the effectiveness against DMI resistant fungi, in particular when compared to the racemic mixtures, or the dextrorotary enantiomer.

For comparison, the dextrorotary enantiomerically pure compound of formula I, wherein R¹ represents chloro; R² represents trifluoromethyl, R³ represents methyl, A represents N, and X represents O, had a [α]_{D}²⁰ value in CHCl₃ of 20.78 [(+) enantiomer of Compound 1-2], whereas the dextrorotary enantiomerically pure compound of formula I, wherein R¹ represents chloro; R² represents chloro, R³ represents methyl, A represents N, and X represents O, had a [α]_{D}²⁰ value in CHCl₃ of 112.93 [(+) enantiomer of Compound I-1].

A further aspect of the present invention is a method of controlling diseases on useful plants or on propagation material thereof caused by DMI resistant Z. tritici phenotype comprising at least one mutation in each of the CYP51 gene, L50S gene and 1381V genes, in particular also for those pheontypes that comprised mutations in genes V136A, YG591, Y461S and S524T, which comprises applying to the useful plants, the locus thereof or propagation material thereof a composition according to the invention. Preferably, the composition may be used also against Z. tritici phenotypes comprising a mutation in genes S188N, A379G and N513K.

In each case, the compounds of formula I according to the invention may be in free form, in oxidized form as a N-oxide or in salt form, e.g. an agronomically usable salt form. N-oxides are oxidized forms of tertiary amines or oxidized forms of nitrogen containing heteroaromatic compounds. They are described for instance in the book “Heterocyclic N-oxides” by A. Albini and S. Pietra, CRC Press, Boca Raton 1991.

A preferred embodiment of the invention is represented by those compositions which comprise a compound of formula (I), wherein A is N and X is O, and most preferably wherein R¹ is chloro, R² is chloro, R³ is methyl, A is N and X is O; or R¹ is chloro, R² is chloro, R³ is ethyl, A is N and X is O; or R¹ is chloro, R² is trifluoromethyl, R³ is methyl, A is N and X is O. These preferred compounds of formula (I) are:

(−)-Methyl 2-[2-chloro-4-(4-chlorophenoxy)phenyl]-2-hydroxy-3-(1,2,4-triazol-1-yl)propanoate [(−) enantiomer of Compound I-1]; and (−)-Methyl 2-[4-(4-chlorophenoxy)-2-(trifluoromethyl) phenyl]-2-hydroxy-3-(1,2,4-triazol-1-yl)propanoate [(−) enantiomer of Compound 1-2].

The present inventions also relates to these compounds, or mixture thereof, or enantiomerically enriched mixtures with the respective dextrorortary enantiomer(s).

For clarification, compound I-1 has the general structure (I-1)

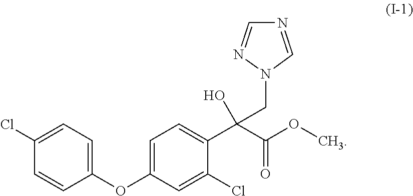 [SMILES: COC(=O)C(O)(Cn1cncn1)c1ccc(Oc2ccc(Cl)cc2)cc1Cl]

For clarification, compound I-2 has the general structure (1-2)

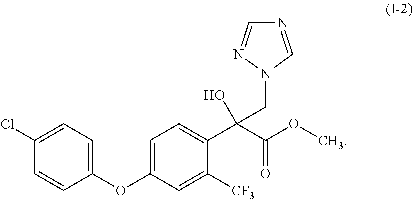 [SMILES: COC(=O)C(O)(Cn1cncn1)c1ccc(Oc2ccc(Cl)cc2)cc1C(F)(F)F]

Further preferred compounds I include the ethyl esters, I-3 and 14, respectively.

For clarification, compound 1-3 has the general structure (1-3)

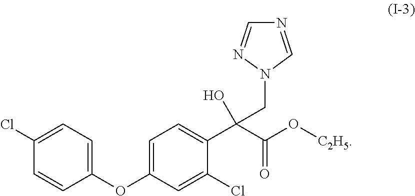 [SMILES: CCOC(=O)C(O)(Cn1cncn1)c1ccc(Oc2ccc(Cl)cc2)cc1Cl]

For clarification, compound I-4 has the general structure (I-4)

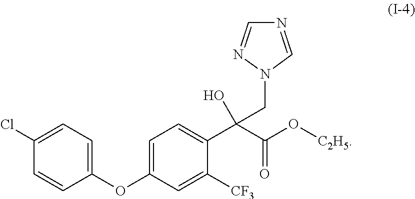 [SMILES: CCOC(=O)C(O)(Cn1cncn1)c1ccc(Oc2ccc(Cl)cc2)cc1C(F)(F)F]

The present invention also relates to compositions comprising compounds I-1, 1-2, 1-3 and I-4, or mixtures thereof, or enantiomerically enriched mixtures of the levorotary compounds with the respective dextrorotary enantiomer(s) thereof.

The compounds of formula (I) may be prepared in analogous manner as outlined in WO 2019/093522, by chemical reactions known in the art, and subsequent separation into the enantiomers, using a preparative HPLC, using a chiral column separation.

Preferred is a method, which comprises applying to the useful plants or to the locus thereof a composition according to the invention, more preferably to the useful plants. Further preferred is a method, which comprises applying to the propagation material of the useful plants a composition according to the invention. The invention covers all mixtures of compounds I in any ratio.

Throughout this document the expression “composition” stands for the various mixtures or combinations of components (A) and at least one additive (B), for example in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the components (A) and (B) is not essential for working the present invention.

Further examples for compositions according to the present invention which comprise three active ingredients are defined as embodiments E1, E2 and E3:

The compositions according to the invention are effective against harmful microorganisms, such as microorganisms, that cause phytopathogenic diseases, in particular against phytopathogenic fungi and bacteria.

The compositions according to the invention may also be employed against phytopathogenic fungi belonging to the following classes: Ascomycetes (e.g. Venturia, Podosphaera, Erysiphe, Monilinia, Mycosphaerella, Uncinula); Basidiomycetes (e.g. the genus Hemileia, Rhizoctonia, Phakopsora, Puccinia, Ustilago, Tilletia); Fungi imperfecti (also known as Deuteromycetes; e.g. Botrytis, Helminthosporium, Rhynchosporium, Fusarium, Zymoseptoria, Cercospora, Alternaria, Pyricularia and Pseudocercosporella); Oomycetes (e.g. Phytophthora, Peronospora, Pseudoperonospora, Albugo, Bremia, Pythium, Pseudosclerospora, Plasmopara), in particuarl those that have developed DMI resistance.

Preferably the (−)-enantiomer of Compound I-1, in enantiomerically pure or enriched form, may be suitably used to control genotypes K9020 Z. tritici CYP51 L50S V136A 1381VY461S S524T, K9026 Z. tritici CYP51 L50S S188N A379G 1381V YG459 N513K and K9029 Z. tritici CYP51 L50S 1381V YG459 N513K. Similarly, the (−)-enantiomer of Compound I-2, in enantiomerically pure or enriched form, may be employed in particular to control genotype K9029 Z. tritici CYP51 L50S 1381V YG459 N513K.

The present invention also relates to a coated plant propagation material, wherein the coating of the plant propagation material comprises a composition comprising an enantiomerically enriched or enantiomerically pure, levorotatory compound of formula (I):

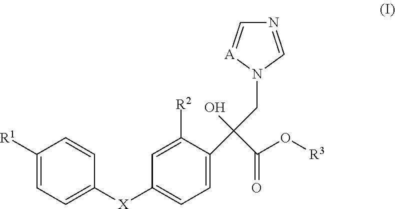

wherein R¹ and R² independently from each other are halogen, cyano, or C₁-C₃ haloalkyl, R³ is hydrogen, C₁-C₃alkyl, C1-C₃alkenyl or C₁-C₃alkynyl, A is CH or N and X is CH₂, C(═O), O or S; preferabvy, a composition as set out herein above.

The present invention advantagaeosuly also relates to the use of an enantiomerically enriched or enantiomerically pure, levorotatory compound of formula (I):

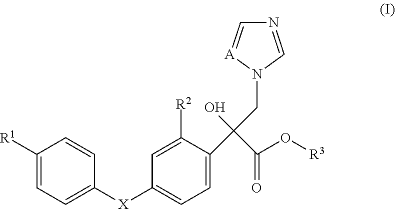

wherein R¹ and R² independently from each other are halogen, cyano, or C₁-C₃ haloalkyl, R³ is hydrogen, C1-C₃alkyl, C₁-C₃alkenyl or C₁-C₃alkynyl, A is CH or N and X is CH₂, C(═O), O or S, for the control of 14α-demethylase inhibitor-resistant pathogenic fungi phenotypes; preferably, for the control of 14α-demethylase inhibitor-resistant Zymoseptoria tritici phenotype comprising at least one mutation in the CYP51 gene, L50S gene and/or 1381V gene.

According to the invention “useful plants” typically comprise the following species of plants: grape vines; cereals, such as wheat, barley, rye or oats; beet, such as sugar beet or fodder beet; fruits, such as pomes, stone fruits or soft fruits, for example apples, pears, plums, peaches, almonds, cherries, strawberries, raspberries or blackberries; leguminous plants, such as beans, lentils, peas or soybeans; oil plants, such as rape, mustard, poppy, olives, sunflowers, coconut, castor oil plants, cocoa beans or groundnuts; cucumber plants, such as marrows, cucumbers or melons; fibre plants, such as cotton, flax, hemp or jute; citrus fruit, such as oranges, lemons, grapefruit or mandarins; vegetables, such as spinach, lettuce, asparagus, cabbages, carrots, onions, tomatoes, potatoes, cucurbits or paprika; lauraceae, such as avocados, cinnamon or camphor; maize; tobacco; nuts; coffee; sugar cane; tea; vines; hops; durian; bananas; natural rubber plants; turf or ornamentals, such as flowers, shrubs, broad-leaved trees or evergreens, for example conifers. This list does not represent any limitation.

The term “useful plants” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors or PPO (protoporphyrinogen-oxidase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate-and glufosinate-resistant maize varieties commercially available under the trade names RoundupReady®, Herculex I® and LibertyLink®.

The term “useful plants” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

The term “useful plants” is to be understood as including also useful plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818, and EP-A-0 353 191. The methods of producing such transgenic plants are generally known to the person skilled in the art and are described, for example, in the publications mentioned above.

The term “locus” of a useful plant as used herein is intended to embrace the place on which the useful plants are growing, where the plant propagation materials of the useful plants are sown or where the plant propagation materials of the useful plants will be placed into the soil. An example for such a locus is a field, on which crop plants are growing.

The term “plant propagation material” is understood to denote generative parts of the plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

In a further aspect, the present application also relates to plant propagation material coated with the compositions according to the invention.

The compositions of the present invention may also be used in the field of protecting storage goods against attack of fungi. According to the present invention, the term “storage goods” is understood to denote natural substances of vegetable and/or animal origin and their processed forms, which have been taken from the natural life cycle and for which long-term protection is desired. Storage goods of vegetable origin, such as plants or parts thereof, for example stalks, leafs, tubers, seeds, fruits or grains, can be protected in the freshly harvested state or in processed form, such as pre-dried, moistened, comminuted, ground, pressed or roasted. Also falling under the definition of storage goods is timber, whether in the form of crude timber, such as construction timber, electricity pylons and barriers, or in the form of finished articles, such as furniture or objects made from wood. Storage goods of animal origin are hides, leather, furs, hairs and the like. The compositions according the present invention can prevent disadvantageous effects such as decay, discoloration or mold. Preferably “storage goods” is understood to denote natural substances of vegetable origin and/or their processed forms, more preferably fruits and their processed forms, such as pomes, stone fruits, soft fruits and citrus fruits and their processed forms. In another preferred embodiment of the invention “storage goods” is understood to denote wood.

Therefore a further aspect of the present invention is a method of protecting storage goods, which comprises applying to the storage goods a composition according to the invention.

The compositions of the present invention may also be used in the field of protecting technical material against attack of fungi. According to the present invention, the term “technical material” includes paper; carpets; constructions; cooling and heating systems; wall-boards; ventilation and air conditioning systems and the like; preferably “technical material” is understood to denote wall-boards. The compositions according the present invention can prevent disadvantageous effects such as decay, discoloration or mold.

The compositions according to the invention may furthermore be particularly effective against seedborne and soilborne diseases, such as Alternaria spp., Ascochyta spp., Botrytis cinerea, Cercospora spp., Claviceps purpurea, Cochliobolus sativus, Colletotrichum spp., Epicoccum spp., Fusarium graminearum, Fusarium moniliforme, Fusarium oxysporum, Fusarium proliferatum, Fusarium solani, Fusarium subglutinans, Gäumannomyces graminis, Helminthosporium spp., Microdochium nivale, Phoma spp., Pyrenophora graminea, Pyricularia oryzae, Rhizoctonia solani, Rhizoctonia cerealis, Sclerotinia spp., Zymoseptoria spp., Sphacelotheca reilliana, Tilletia spp., Typhula incarnata, Urocystis occulta, Ustilag ospp. or Verticillium spp.; in particular against pathogens of cereals, such as wheat, barley, rye or oats; maize; rice; cotton; soybean; turf; sugarbeet; oil seed rape; potatoes; pulse crops, such as peas, lentils or chickpea; and sunflower.

The compositions according to the invention may furthermore be particularly effective against post harvest diseasese such as Botrytis cinerea, Colletotrichum musae, Curvularia lunata, Fusarium semitecum, Geotrichum candidum, Monilinia fructicola, Monilinia fructigena, Monilinia laxa, Mucor piriformis, Penicilium italicum, Penicilium solitum, Penicillium digitatum or Penicillium expansum in particular against pathogens of fruits, such as pomefruits, for example apples and pears, stone fruits, for example peaches and plums, citrus, melons, papaya, kiwi, mango, berries, for example strawberries, avocados, pomegranates and bananas, and nuts.

However, besides the actual synergistic action with respect to fungicidal activity, the compositions according to the invention can also have further surprising advantageous properties. Examples of such advantageous properties that may be mentioned are: more advantageuos degradability; improved toxicological and/or ecotoxicological behaviour; or improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination.

Some compositions according to the invention have a systemic action and can be used as foliar, soil and seed treatment fungicides.

With the compositions according to the invention it is possible to inhibit or destroy the phytopathogenic microorganisms which occur in plants or in parts of plants (fruit, blossoms, leaves, stems, tubers, roots) in different useful plants, while at the same time the parts of plants which grow later are also protected from attack by phytopathogenic microorganisms.

The compositions according to the invention can be applied to the phytopathogenic microorganisms, the useful plants, the locus thereof, the propagation material thereof, storage goods or technical materials threatened by microorganism attack.

The compositions according to the invention may be applied before or after infection of the useful plants, the propagation material thereof, storage goods or technical materials by the microorganisms.

The amount of a composition according to the invention to be applied, will depend on various factors, such as the compounds employed; the subject of the treatment, such as, for example plants, soil or seeds; the type of treatment, such as, for example spraying, dusting or seed dressing; the purpose of the treatment, such as, for example prophylactic or therapeutic; the type of fungi to be controlled or the application time.

When applied to the useful plants component (I) is typically applied at a rate of 5 to 2000 g a.i./ha, particularly 10 to 1000 g a.i./ha, e.g. 50, 75, 100 or 200 g a.i./ha.

In agricultural practice the application rates of the compositions according to the invention depend on the type of effect desired, and typically range from 20 to 4000 g of total composition per hectare.

When the compositions according to the invention are used for treating seed, rates of 0.001 to 50 g of a compound (I) per kg of seed, preferably from 0.01 to 10 g per kg of seed, are generally sufficient.

The composition of the invention may be employed in any conventional form, for example in the form of a twin pack, a powder for dry seed treatment (DS), an emulsion for seed treatment(ES), a flowable concentrate for seed treatment (FS), a solution for seed treatment (LS), a water dispersible powder for seed treatment (WS), a capsule suspension for seed treatment (CF), a gel for seed treatment (GF), an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP) or any technically feasible formulation in combination with agriculturally acceptable adjuvants.

Such compositions may be produced in conventional manner, e.g. by mixing the active ingredients with at least one appropriate inert formulation adjuvant (for example, diluents, solvents, fillers and optionally other formulating ingredients such as surfactants, biocides, anti-freeze, stickers, thickeners and compounds that provide adjuvancy effects). Also conventional slow release formulations may be employed where long lasting efficacy is intended. Particularly formulations to be applied in spraying forms, such as water dispersible concentrates (e.g. EC, SC, DC, OD, SE, EW, EO and the like), wettable powders and granules, may contain surfactants such as wetting and dispersing agents and other compounds that provide adjuvancy effects, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

The compositions according to the invention may also comprise further pesticides, such as, for example, fungicides, insecticides or herbicides.

A seed dressing formulation is applied in a manner known per se to the seeds employing the compositions according to the invention and a diluent in suitable seed dressing formulation form, e.g. as an aqueous suspension or in a dry powder form having good adherence to the seeds. Such seed dressing formulations are known in the art. Seed dressing formulations may contain the single active ingredients or the combination of active ingredients in encapsulated form, e.g. as slow release capsules or microcapsules.

In general, the formulations include from 0.01 to 90% by weight of active agent, from 0 to 20% agriculturally acceptable surfactant and 10 to 99.99% solid or liquid formulation inerts and adjuvant(s), the active agent consisting of at least a compound (I), and optionally other active agents, particularly microbiocides or conservatives or the like. Concentrated forms of compositions generally contain in between about 2 and 80%, preferably between about 5 and 70% by weight of active agent. Application forms of formulation may for example contain from 0.01 to 20% by weight, preferably from 0.01 to 5% by weight of active agent. Whereas commercial products will preferably be formulated as concentrates, the end user will normally employ diluted formulations.

Further characteristics of compositions comprising compounds of formula (I), their application methods to plants and their use rates are as described for compositions comprising compounds of formula (I) and additionally at least one component (B) as described above.

Their application can be both before and after the infection of the plants or parts thereof with the fungi. The treatment is preferably carried out prior to the infection. When a compound of formula (I) is used on its own, the application rates in the method accoding to the invention are as described above, e.g. typical are rates of 5 to 2000 g a.i./ha, particularly 10 to 1000 g a.i./ha, e.g. 50, 75, 100 or 200 g a.i./ha. Compounds of formula (I) can be applied to the plants once or more than once during a growing season. For use in the method according to the invention, the compounds of formula (I) can be converted into the customary formulations described above, e.g. solutions, emulsions, suspensions, dusts, powders, pastes and granules. The use form will depend on the particular intended purpose; in each case, it should ensure a fine and even distribution of the compound of formula (I).

The term “plant” as used herein includes seedlings, bushes and crops of fruits and vegetables.

The Examples which follow serve to illustrate the invention, “active ingredient” denotes a mixture of component (I).

The same formulations can be used for compositions comprising only a compound of formula (I) as the active ingredient, as set out in the following tables.

### Formulation Examples

TABLE 1

| Wettable powders | a) | b) |
|---|---|---|
| active ingredient [Compound I] | 25% | 75% |
| sodium lignosulfonate | 5% | — |
| sodium lauryl sulfate | 3% | 5% |
| sodium diisobutylnaphthalenesulfonate | — | 10% |
| (7-8 mol of ethylene oxide) | | |
| highly dispersed silicic acid | 5% | 10% |
| Kaolin | 62% | — |

The active ingredient is thoroughly mixed with the other formulation components and the mixture is thoroughly ground in a suitable mill, affording wettable powders that can be diluted with water to give suspensions of the desired concentration.

TABLE 2

| Powders for dry seed treatment | a) | b) |
|---|---|---|
| active ingredient [Compound I] | 25% | 75% |
| light mineral oil | 5% | 5% |
| highly dispersed silicic acid | 5% | — |
| kaolin | 65% | — |
| Talc | — | 20 |

The active ingredient is thoroughly mixed with the other formulation components and the mixture is thoroughly ground in a suitable mill, affording powders that can be used directly for seed treatment.

TABLE 3

| Emulsifiable concentrate | |
|---|---|
| active ingredient [Compound I] | 10% |
| octylphenol polyethylene glycol ether | 3% |
| (4-5 mol of ethylene oxide) | |
| calcium dodecylbenzenesulfonate | 3% |
| castor oil polyglycol ether (35 mol of ethylene oxide) | 4% |
| cyclohexanone | 30% |
| xylene mixture | 50% |

Emulsions of any required dilution, which can be used in plant protection, can be obtained from this concentrate by dilution with water.

TABLE 4

| Dustable powders | a) | b) |
|---|---|---|
| active ingredient [Compound I] | 5% | 6% |
| Talcum | 95% | — |
| Kaolin | — | 94% |

Ready-for-use dusts are obtained by mixing the active ingredient with the carriers and grinding the mixture in a suitable mill. Such powders can also be used for dry dressings for seed.

TABLE 5

| Extruded granules | % w/w |
|---|---|
| active ingredient [Compound I] | 15% |
| sodium lignosulfonate | 2% |
| sodium alkyl naphthalene sulfonate | 1% |
| Kaolin | 82% |

The active ingredient is mixed and ground with the other formulation components, and the mixture is moistened with water. The mixture is extruded and then dried in a stream of air.

### Suspension Concentrate

TABLE 6

| | |
|---|---|
| active ingredient [Compound I] | 40% |
| propylene glycol | 10% |
| nonylphenol polyethylene glycol ether (15 mol of ethylene oxide) | 6% |
| sodium lignosulfonate | 10% |
| carboxymethylcellulose | 1% |
| silicone oil (in the form of a 75% emulsion in water) | 1% |
| water | 32% |

The finely ground active ingredient is intimately mixed with the other formulation components, giving a suspension concentrate which can be diluted in water at any desired rate. Using such dilutions, living plants as well as plant propagation material can be treated and protected against infestation by microorganisms, by spraying, pouring or immersion.

### Flowable Concentrate for Seed Treatment

TABLE 7

| | |
|---|---|
| active ingredient [Compound I] | 40% |
| propylene glycol | 5% |
| copolymer butanol PO/EO | 2% |
| tristyrenephenole ethoxylate (with 10-20 moles EO) | 2% |
| 1,2-benzisothiazolin-3-one | 0.5% |
| monoazo-pigment calcium salt | 5% |
| silicone oil (in the form of a 75% emulsion in water) | 0.2% |
| water | 45.3% |

The finely ground active ingredient is intimately mixed with the other formulation components, giving a suspension concentrate which can be diluted further in water to be applied to seeds. Using such dilutions, propagation material can be treated and protected against infestation by microorganisms, by spraying, pouring or immersion.

Accordingly a further aspect of the present invention is a method of controlling leaf spot diseases on plants which comprises applying to the plants, the locus thereof or propagation material thereof a composition comprising a compound of formula (I).

Preferred is a method wherein the phytopathogen is attacking plants and causing diseases, like leaf spots, powdery mildews, and fungal blight diseases.

Preferred is a method, which comprises applying to the plants or to the locus thereof a composition comprising a compound of formula (I), preferably to the plants.

Further prefered is a method, which comprises applying to the propagation material of the plants a composition comprising a compound of formula (I) Yet further, the present invention also relates to the use of a composition according to the invention for controlling leaf spot diseases on plants.

The methods according to the invention, especially when a compound of formula (I) is used in combination with at least one compound (B) as described above, also allows good control of other harmful fungi frequently encountered in plants.

Preferred is a method of controlling diseases on oilseeds and cereals, especially caused by leaf spot diseases, which comprises applying to the useful plants, the locus thereof or propagation material thereof a composition comprising an enantiomerically pure or enriched compound of formula (I)

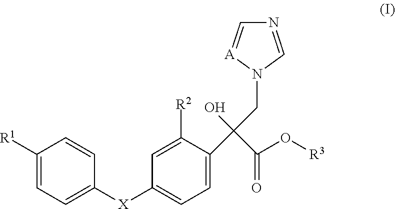

wherein R¹ and R² independently from each other are fluoro, chloro or trifluoromethyl, R³ is methyl or ethyl, A is N and X is C(═O) or O.

It has been found, surprisingly, that enantiomerically pure or enriched compoudns (I), in particular those that are levorotary, are able to give rise to higher activity as compared to the racemic mixtures.

The efficacy was measured and calculated by comparing the EC₅₀ values of the racemate versus the EC₅₀ values of the pure enantiomers. The acticvity of the enantiomers was tested by comparing tests of the enantiomers with the racemate, and then calculating the following value:

$$( {EC}_{50} ( enantiomer ) / {EC}_{50} ( racemate ) ) - 0.5 = M ( Measured value ) .$$

A measured value M of 0 represents the situation wherein the racemate and the enantiomers show no difference in efficacy. A value M above 0 indicates that the racemate is more effective, whereas a value below 0 indicates that the enantiomer outperforms the racemate.

Assuming the active enantiomer of DMI contributes fully to the racemate activity, it should be double as active. As such the quotient of EC enantiomer/EC racemate should be 0.5. A subtraction of 0.5 from the quotient should result in 0. If the active enantiomer is not fully contributing, the resultant outcome would be positive, but if enantiomer is much more active than expected, the outcome would be negative.

It was shown that the (−)-enantiomers of compounds of formula (I) showed a reproducible and unexpectedly enhanced enhanced activity at least vis-a-vis DMI tolerant genotypes of Z. Tritici, showing the enantiomers showing a pronounced and stable activity on DMI tolerant genotypes of Zymoseptoria tritici with mutations in genes CYP51, L50S, 1381V, YG459 and N513K; Zymoseptoria tritici with mutations in genes CYP51, L50S, V136A, 1381V, Y461S and S524T; and Zymoseptoria tritici with mutations in genes CYP51, L50S, S188N, A379G, 1381V, YG459 and N513K.

### Biological Examples

A panel of 16 Zymoseptoria tritici isolates was subjected to in vitro antifungal tests. Spore suspensions of Z. tritici isolates were prepared in potato dextrose broth (PDB) and exposed to defined concentration ranges of the inhibitors (20ppm starting concentration, dilution steps of 3). A sensitive wild-type isolate was used together with a panel of strains containing variants of the Z. tritici CYP51 gene conferring resistance to DMI fungicides. The DMI-resistant isolates were isolated from wheat in the UK, Ireland, Germany and Russia in 2020. Determination of CYP51 gene variants was achieved using targeted gene sequencing. The half maximal effective concentration (EC50) of the inhibitors were calculated based on growth responses of Z. tritici at 3 days post exposure to the different concentrations of the agonists using a linear regression. The Tables A and B show an average of EC50 values in ppm from two replicates, as well as M=(EC50 (enantiomer)/EC50 (racemate))−0.5.

TABLE A

| | EC50 (ppm) | | | |
|---|---|---|---|---|
| | Compounds | | | |
| | Racemate | (+)-enantiomer | (−)-enantiomer | |
| Zymoseptoria tritici isolate | Compound I-1 | of Compound I-1 | of Compound I-1 | M* |
| K5544 Zymoseptoria tritici (WT) | 0.03 | 1 | 0.02 | 0.17 |
| K9020 Zymoseptoria tritici | 0.03 | 2 | 0.01 | −0.17 |
| CYP51 L50S V136A I381V Y461S | | | | |
| S524T | | | | |
| K9021 Zymoseptoria tritici | 0.09 | 5 | 0.04 | −0.06 |
| CYP51 L50S V136A I381V Y461S | | | | |
| S524T | | | | |
| K9022 Zymoseptoria tritici | 0.6 | 20 | 0.3 | 0.00 |
| CYP51 L50S V136A I381V Y461S | | | | |
| S524T | | | | |
| K9023 Zymoseptoria tritici | 0.5 | 20 | 0.3 | 0.10 |
| CYP51 L50S V136C S188N A379G | | | | |
| I381V YG459 S524T | | | | |
| K9023 Zymoseptoria tritici | 0.2 | 9 | 0.1 | 0.00 |
| CYP51 L50S V136C S188N A379G | | | | |
| I381V YG459 S524T | | | | |
| K9023 Zymoseptoria tritici | 0.4 | 19 | 0.2 | 0.00 |
| CYP51 L50S V136C S188N A379G | | | | |
| I381V YG459 S524T | | | | |
| K9026 Zymoseptoria tritici | 10 | 20 | 4 | −0.10 |
| CYP51 L50S S188N A379G I381V | | | | |
| YG459 N513K | | | | |
| K9026 Zymoseptoria tritici | 0.1 | 5 | 0.05 | 0.00 |
| CYP51 L50S S188N A379G I381V | | | | |
| YG459 N513K | | | | |
| K9026 Zymoseptoria tritici | 0.1 | 3 | 0.05 | 0.00 |
| CYP51 L50S S188N A379G I381V | | | | |
| YG459 N513K | | | | |
| K9029 Zymoseptoria tritici | 0.8 | 20 | 0.3 | −0.13 |
| CYP51 L50S I381V YG459 N513K | | | | |
| K9029 Zymoseptoria tritici | 3 | 20 | 0.8 | −0.23 |
| CYP51 L50S I381V YG459 N513K | | | | |
| K9029 Zymoseptoria tritici | 10 | 20 | 3 | −0.20 |
| CYP51 L50S I381V YG459 N513K | | | | |
| K9032 Zymoseptoria tritici | 0.2 | 12 | 0.1 | 0.00 |
| CYP51 L50S D134G V136A I381V | | | | |
| Y461H S524T | | | | |
| K9032 Zymoseptoria tritici | 0.1 | 7 | 0.06 | 0.10 |
| CYP51 L50S D134G V136A I381V | | | | |
| Y461H S524T | | | | |
| K9032 Zymoseptoria tritici | 0.1 | 8 | 0.06 | 0.10 |
| CYP51 L50S D134G V136A I381V | | | | |
| Y461H S524T | | | | |

*M = (EC50 (enantiomer)/EC50 (racemate)) − 0.5. A value M above 0 indicates that the racemate is more effective, whereas a value below 0 indicates that the enantiomer outperforms the racemate.

TABLE B

| | EC50 (ppm) | | | |
|---|---|---|---|---|
| | Compounds | | | |
| | Racemate | (+)-enantiomer | (−)-enantiomer | |
| Zymoseptoria tritici isolate | Compound I-2 | of Compound I-2 | of Compound I-2 | M* |
| K5544 Zymoseptoria tritici (WT) | 0.03 | 0.5 | 0.03 | 0.50 |
| K9020 Zymoseptoria tritici | | | | |
| CYP51 L50S V136A I381V Y461S | 0.03 | 1 | 0.02 | 0.17 |
| S524T | | | | |
| K9021 Zymoseptoria tritici | 0.09 | 3 | 0.05 | 0.06 |
| CYP51 L50S V136A I381V Y461S | | | | |
| S524T | | | | |
| K9022 Zymoseptoria tritici | 0.7 | >20 | 0.4 | 0.07 |
| CYP51 L50S V136A I381V Y461S | | | | |
| S524T | | | | |
| K9023 Zymoseptoria tritici | 0.3 | 9 | 0.3 | 0.50 |
| CYP51 L50S V136C S188N A379G | | | | |
| I381V YG459 S524T | | | | |
| K9023 Zymoseptoria tritici | 0.1 | 6 | 0.1 | 0.50 |
| CYP51 L50S V136C S188N A379G | | | | |
| I381V YG459 S524T | | | | |
| K9023 Zymoseptoria tritici | 0.3 | 9 | 0.2 | 0.17 |
| CYP51 L50S V136C S188N A379G | | | | |
| I381V YG459 S524T | | | | |
| K9026 Zymoseptoria tritici | 6 | >20 | 3 | 0.00 |
| CYP51 L50S S188N A379G I381V | | | | |
| YG459 N513K | | | | |
| K9026 Zymoseptoria tritici | 0.07 | 3 | 0.05 | 0.21 |
| CYP51 L50S S188N A379G I381V | | | | |
| YG459 N513K | | | | |
| K9026 Zymoseptoria tritici | 0.07 | 2 | 0.04 | 0.07 |
| CYP51 L50S S188N A379G I381V | | | | |
| YG459 N513K | | | | |
| K9029 Zymoseptoria tritici | 0.8 | >20 | 0.5 | 0.13 |
| CYP51 L50S I381V YG459 N513K | | | | |
| K9029 Zymoseptoria tritici | 3 | >20 | 1 | −0.17 |
| CYP51 L50S I381V YG459 N513K | | | | |
| K9029 Zymoseptoria tritici | 10 | >20 | 5 | 0.00 |
| CYP51 L50S I381V YG459 N513K | | | | |
| K9032 Zymoseptoria tritici | 0.2 | 7 | 0.1 | 0.00 |
| CYP51 L50S D134G V136A I381V | | | | |
| Y461H S524T | | | | |
| K9032 Zymoseptoria tritici | 0.1 | 4 | 0.07 | 0.20 |
| CYP51 L50S D134G V136A I381V | | | | |
| Y461H S524T | | | | |
| K9032 Zymoseptoria tritici | 0.1 | 4 | 0.08 | 0.30 |
| CYP51 L50S D134G V136A I381V | | | | |
| Y461H S524T | | | | |

*M = (EC50 (enantiomer)/EC50 (racemate)) − 0.5. A value M above 0 indicates that the racemate is more effective, whereas a value below 0 indicates that the enantiomer outperforms the racemate.

As shown in Table A, the (−)-enantiomer of Compound I-1 outperforms the racemate Compound I-1 in several instances and is more effective against K9020 Z. tritici CYP51 L50S V136A 1381V Y461S S524T, K9026 Z. tritici CYP51 L50S S188N A379G 1381V YG459 N513K and K9029 Z. tritici CYP51 L50S 1381V YG459 N513K. Similarly, shown in Table B, the (−)-enantiomer of Compound I-2 outperforms the racemate Compound I-2 and is more effective against the isolate K9029 Z. tritici CYP51 L50S 1381V YG459 N513K.

1. A composition for the control of a 14α-demethylase inhibitor-resistant Zymoseptoria tritici phenotype comprising at least one mutation in the CYP51 gene, L50S gene and/or I381V gene, comprising:
(A) an enantiomerically enriched or enantiomerically pure, levorotatory compound of formula (I) 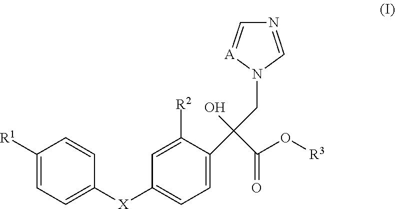
wherein R¹ and R² independently from each other are halogen, cyano, or C₁-C₃ haloalkyl, R³ is hydrogen, C₁-C₃alkyl, C1-Csalkenyl or C1-C₃alkynyl, A is CH or N and X is CH2, C (=O), O or S, wherein compound (A) is not levorotatory (−)-Methyl 2-[2-chloro-4-(4-chlorophenoxy)phenyl]-2-hydroxy-3-(1, 2,4-triazol-1-yl)propanoate in 90% ee enatiomeric excess over the dextrorotatory (+)-Methyl 2-[2-chloro-4-(4-chlorophenoxy)phenyl]-2-hydroxy-3-(1,2,4-triazol-1-yl) propanoate, if present as the sole compound (A) of formula (I).

2. A composition according to claim 1, further comprising at least one further agrochemically active component (B).

3. A composition according to claim 1, wherein in compound (A), R¹ and R² independently from each other are fluoro, chloro or trifluoromethyl, R³ is methyl or ethyl, A is N and X is C(═O) or O, or an agrochemically acceptable salt or N-oxide thereof.

4. A composition according to claim 1, wherein in component (A), R¹ and R² independently from each other are chloro or trifluoromethyl, and wherein R³ is methyl or ethyl.

5. A composition according to claim 1, wherein in component (A) A is N.

6. A composition according to claim 1, wherein in component (A), X is C(═O) or O.

7. A composition according to claim 1, wherein component (A) is an enantiomerically enriched or enantiomerically pure composition comprising essentially levorotary methyl 2-[2-chloro-4-(4-chlorophenoxy)phenyl]-2-hydroxy-3-(1,2, 4-triazol-1-yl)propanoate; levorotary ethyl 2-[2-chloro-4-(4-chlorophenoxy)phenyl]-2-hydroxy-3-(1, 2,4-triazol-1-yl)propanoate, levorotary methyl 2-[4-(4-chlorophenoxy)-2-(trifluoromethyl) phenyl]-2-hydroxy-3-(1,2,4-triazol-1-yl) propanoate, or levorotary ethyl 2-[4-(4-chlorophenoxy)-2-(trifluoromethyl) phenyl]-2-hydroxy-3-(1,2,4-triazol-1-yl) propanoate, or combinations, or mixtures thereof.

8. A composition according to claim 1, wherein component (B) is at least one or more further insecticidally, acaricidally, nematicidally and/or fungicidally active agent, wherein component B is not a dextrorotary enantiomer according to formula (I).

9. A composition according to claim 1, wherein the weight ratio of (A) to (B) is in the range of from 2000:1 to 1:2000.

10. A composition according to claim 1, wherein the weight ratio of (A) to (B) is in the range of from 100:1 to 1:100; preferably 40:1 to 1:40; more preferably 25:1 to 1:25; yet more preferably of from 5:1 to 1:5; and again more preferably of from 2:1 to 1:2.

11. A composition according to claim 1, further comprising an agriculturally acceptable carrier and, optionally, a surfactant, uptake enhancer and/or formulation adjuvant(s).

12. A method of controlling 14a-demethylase inhibitor-resistant Zymoseptoria tritici phenotypes, preferably phenotyps comprising at least one mutation in the CYP51 gene, L50S gene and/or I381V gene, on useful plants or on propagation material thereof caused by phytopathogens, comprising applying to the useful plants, the locus thereof or propagation material thereof a composition comprising (A) an enantiomerically enriched or enantiomerically pure, levorotatory compound of formula (I): 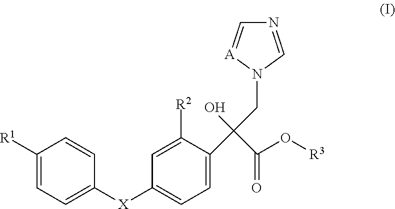
wherein R¹ and R² independently from each other are halogen, cyano, or C₁-C₃ haloalkyl, R³ is hydrogen, C₁-C₃alkyl, C1-C₃alkenyl or C1-Csalkynyl, A is CH or N and X is CH₂, C(═O), O or S.

13. A method according to claim 12, wherein component (A) comprises an enantiomerically enriched or enantiomerically pure composition comprising essentially levorotary methyl 2-[2-chloro-4-(4-chlorophenoxy)phenyl]-2-hydroxy-3-(1,2, 4-triazol-1-yl)propanoate; levorotary ethyl 2-[2-chloro-4-(4-chlorophenoxy)phenyl]-2-hydroxy-3-(1,2, 4-triazol-1-yl)propanoate, levorotary methyl 2-[4-(4-chlorophenoxy)-2-(trifluoromethyl)phenyl]-2-hydroxy-3-(1, 2,4-triazol-1-yl) propanoate, or levorotary ethyl 2-[4-(4-chlorophenoxy)-2-(trifluoromethyl) phenyl]-2-hydroxy-3-(1,2,4-triazol-1-yl)propanoate, or combinations, or mixtures thereof.

14. A method according to claim 12, wherein the composition is a composition thereof.

15. A method according to claim 14, wherein components (A) and (B), as applicable, are applied in a simultaneous, intermittant, or sequential manner.

16. A coated plant propagation material, wherein the coating of the plant propagation material comprises a composition comprising an enantiomerically enriched or enantiomerically pure, levorotatory compound of formula (I): 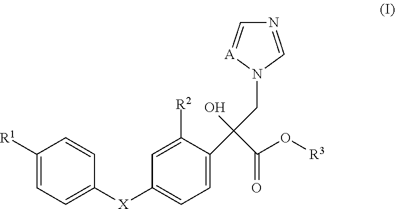
wherein R¹ and R² independently from each other are halogen, cyano, or C₁-C₃ haloalkyl, R³ is hydrogen, C₁-C₃alkyl, C₁-Csalkenyl or C1-C₃alkynyl, A is CH or N and X is CH₂, C(═O), O or S; preferably, a composition according to claim 1.

17. Use of an enantiomerically enriched or enantiomerically pure, levorotatory compound of formula (I): 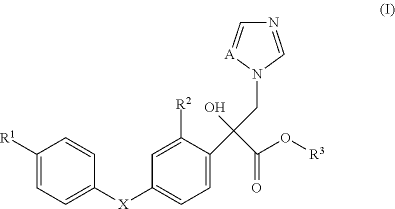
wherein R¹ and R² independently from each other are halogen, cyano, or C₁-C₃ haloalkyl, R³ is hydrogen, C₁-C₃alkyl, C1-Csalkenyl or C1-Csalkynyl, A is CH or N and X is CH₂, C(═O), O or S, for the control of 14α-demethylase inhibitor-resistant pathogenic fungi phenotypes.

18. Use according to claim 17, for the control of 14α-demethylase inhibitor-resistant Zymoseptoria tritici phenotype comprising at least one mutation in the CYP51 gene, L50S gene and/or I381V gene.
